(19) United States
(12) Patent Application Publication
(10) Pub. No.: US 2017/0270284 A1
(43) Pub. Date: Sep. 21, 2017

(54) CONVERTING LICENSES FROM ONE PRODUCT TO ANOTHER PRODUCT

(71) Applicant: VMware, Inc., Palo Alto, CA (US)

(72) Inventors: Sreenidhi SREESHA, Sunnyvale, CA (US); Wit RIEWRANGBOONYA, Mountain View, CA (US); Dave SHANLEY, Fremont, CA (US); Aleksey LIB, Foster City, CA (US)

(73) Assignee: VMware, Inc., Palo Alto, CA (US)

(21) Appl. No.: 15/070,299

(22) Filed: Mar. 15, 2016

(51) Int. Cl. G06F 21/10

(52) U.S. Cl. CPC G06F 21/105

(57) ABSTRACT

A method for converting licenses from one product to another product is described. The method includes: accessing client product license information for a client, wherein the client product license information comprises product licenses acquired by the client; determining if the client product license information comprises an available license that covers the first product and that could cover the second product associated with the client; and if a status determination is made that the available license exists, then presenting a discovered available license for conversion from covering the first product to cover the second product.

### FIELD OF THE INVENTION

This invention generally relates to re-using product licenses.

### BACKGROUND

Conventionally, when a client purchases a product, such as an application, he also purchases a license to use that product. Sometimes, products are combined and offered for sale as a set of products. This set of products may include that product for which the client has already purchased a license. The client is then asked to purchase a license to use that product, within the set of products, for which a license has already been purchased.

Thus, clients are being charged twice for a single product (e.g., application). The current method of charging twice for a product's license has the potential effect of alienating important and existing clients.

### BRIEF DESCRIPTION OF DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a product license converter, in accordance with an embodiment.

FIG. 2 is a block diagram of a hyper-converged appliance including a product license converter, in accordance with an embodiment.

FIG. 3 is a block diagram of an example table of product license information as compared to the product license information for the client, in accordance with an embodiment.

FIG. 4 is a flow diagram for a method for converting licenses form a first product to a second product, in accordance with an embodiment.

FIG. 5 is a block diagram of an example computer system with which or upon which various embodiments of the present invention may be implemented.

FIG. 6 is a block diagram of a system for converting licenses from a first product to a second product, in accordance with an embodiment.

### DESCRIPTION OF EMBODIMENTS

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

### Notation and Nomenclature

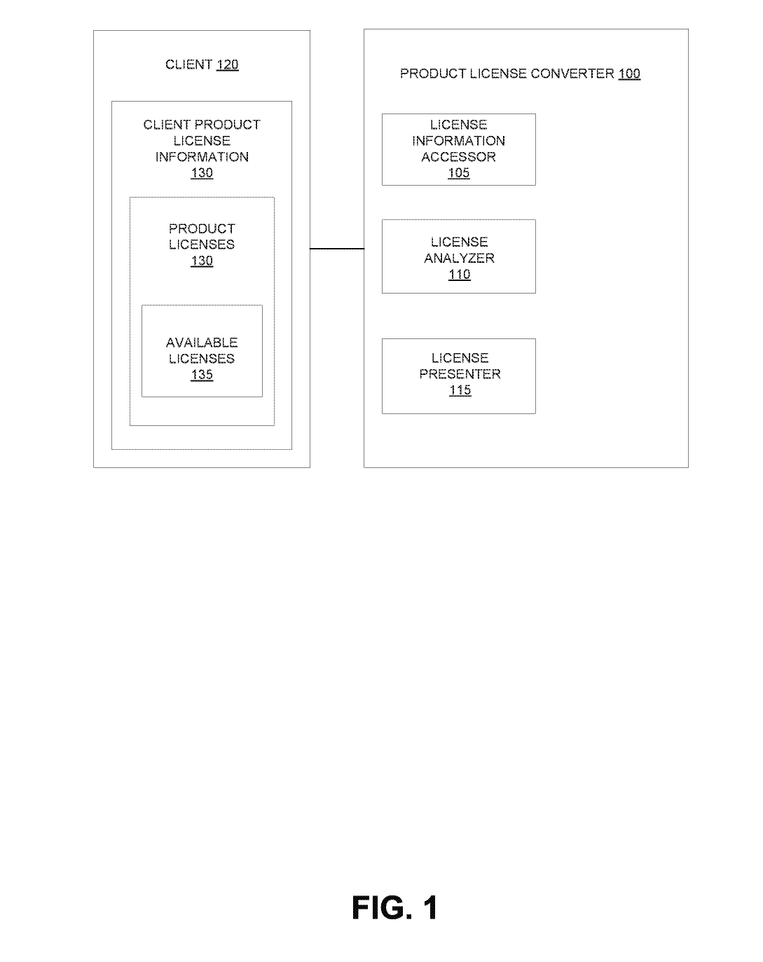

Unless specifically stated otherwise as apparent from the following discussions, it is appreciated that throughout the present Description of Embodiments, discussions utilizing terms and variation of such terms such as “accesses”, “determines”, “presents”, “acquires”, “purchases”, “converts”, “compares”, “matches”, or the like, often refer to the actions and processes of an electronic computing device (or portion thereof), module or system, such as, but not limited to, a product license converter (See FIGS. 1-3), unless noted otherwise. The electronic computing device/module/system transmits, receives, stores, manipulates and/or transforms signals represented as physical (electrical) quantities within the circuits, components, logic, and the like, of the electronic computing device/system into other signals similarly represented as physical electrical quantities within the electronic computing device/system or within or transmitted to other electronic computing devices/systems.

### Overview of Embodiments and Discussion

Conventionally, when a client purchases a product, such as an application, he also purchases a license to use that product. Sometimes, products are combined and offered for sale as a set of products. This set of products may include that product for which the client has already purchased a license. The client is then asked to purchase a license to use that product, within the set of products, for which a license has already been purchased.

Thus, clients are being charged twice for a single product (e.g., application). The current method of charging twice for a product's license has the potential effect of alienating important and existing clients. What is needed is a method and system for enabling a consumer to use an already purchased product license for a new product.

Embodiments of the present technology provide a solution, via a product license converter, and methods described herein, for converting licenses from one product to another product.

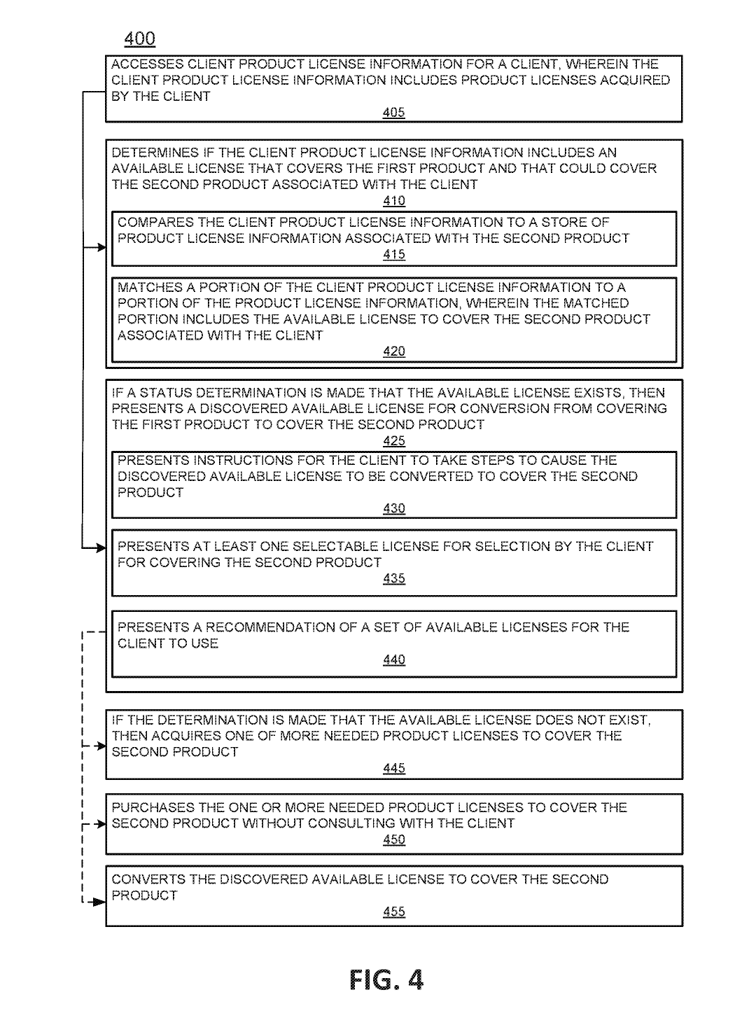

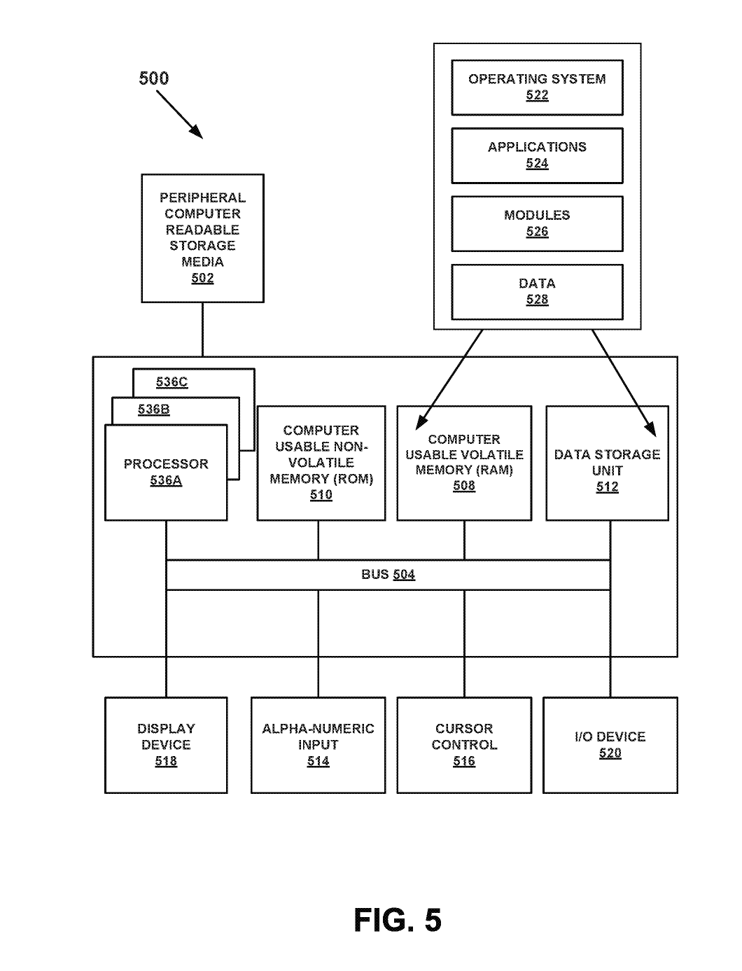

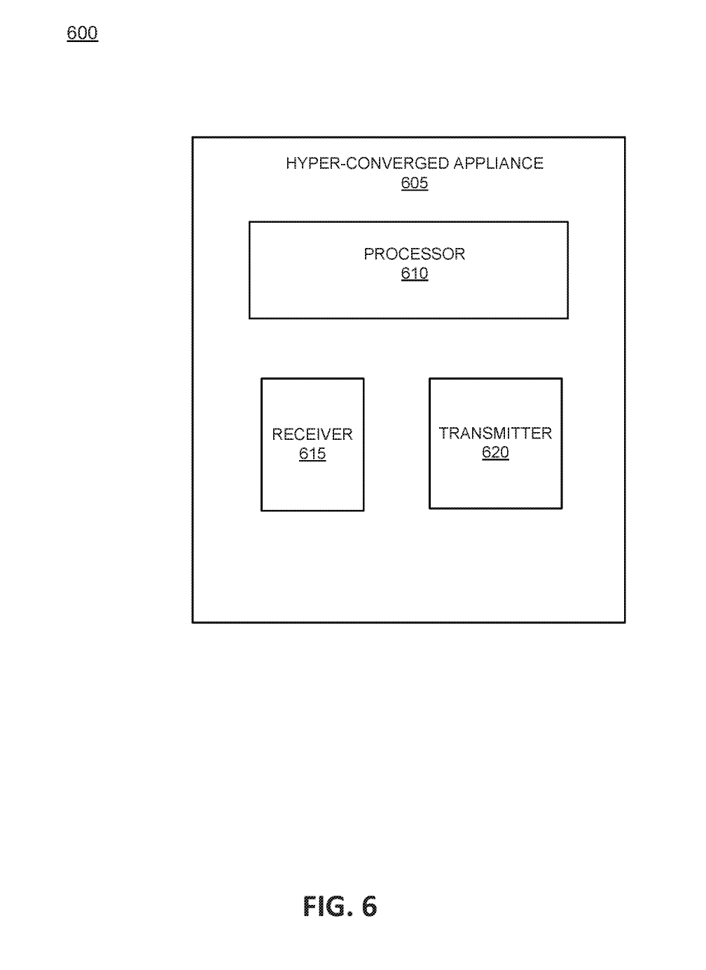

The following discussion will begin with a glossary of terms. The discussion continues with a general description of embodiments. Then, a more detailed description of embodiments ensues, including a description of a product license converter and a system that includes the product license converter (FIGS. 1-3), a method (FIG. 4) for converting licenses from one product to another product, as well as yet another system for converting licenses from on product to another (FIG. 6), in accordance with an embodiment. With reference to FIG. 5, the discussion concludes with a description of an example computer system with which or upon which various embodiments of the present technology may be implemented.

### Glossary

Hyper-Converged Appliance: A hyper-converged appliance (“HCA”) is a type of infrastructure system with a software-centric architecture that tightly integrates compute, storage, networking and virtualization resources and other technologies from scratch in a commodity hardware box supported by a single vendor. A hyper-converged system allows the integrated technologies to be managed as a single system through a common toolset. Hyper-converged systems can be expanded through the addition of nodes to the base unit. Common use cases include virtualized workloads to control the hyper-converged appliance. For example, a Linux Container™ (LXC™) is a workload that has operating system-level capabilities which make it possible to run multiple isolated Linux™ systems or containers, on one control host (the LXC™ host). LXC™ serves as a lightweight alternative to full machine virtualization via hypervisors like KVM™, VMware's ESXi™ or Xen™. The technologies in a hyper-converged infrastructure are so integrated that they cannot be broken down into separate components. (Margaret Rouse. (Oct. 25, 2015) What is hyper-convergence? Definition from WhatIs.com [Online]. Available: http://searchvirtualstorage.techtarget.com/definition/hyper-convergence.) For example, one type of HCA is “EVO:RAIL Hyper-Converged Infrastructure Appliance”™ (“EVO:RAIL™”) by VMware™. EVO:RAIL™ combines compute, network, storage and management into a hyper-converged infrastructure appliance. (VMware [2015] EVO:RAIL Hyper-Converged Infrastructure Appliance: VMware [Online]. Available: https://www.vmware.com/products/evorail.)

Client: A client is a person or organization using the product and/or services of another professional person or company.

### General Description of Invention

Various embodiments provide a system and method for converting licenses from one product to another product. The following is a general case scenario involving a system and/or method of the present technology. A client acquires a product, such as an HCA. For clarity, an HCA will be used herein in as the “second product” with regard to a description of embodiments. However, it should be appreciated that the second product may be a product other than an HCA.

The HCA which the client purchased, in one embodiment, includes three integrated components, “A”, “B”, and “C” (which are products that may be or have been sold individually and separately). However, the client has also already purchased the products “A” and “C” separately, as well as the product licenses accompanying these components. When purchasing the HCA, the client wishes to only pay for the license for component “B”. The client does not wish to pay for multiple licenses that cover the operation of the HCA (that includes multiple components. More specifically, the client does not wish to pay again for a license to use the products “A” and “C” within the HCA. Embodiments of the present technology enable the client to only purchase product licenses for components of an HCA for which the client has not already purchased individual licenses.

For example, residing on the HCA is a product license converter. The product license converter looks at the client product licenses that the client has acquired, compares these product licenses to a table of product license information, and then determines which client product licenses are unused and convertible and which cover particular components of the HCA. If it is determined that the client's product licenses for products “A” and “C” will be unused during the use of the HCA, then the product license converter determines that the client's product license for products “A” and “C” will substitute for a portion of the product license required to be purchased for the HCA. Client will only have to pay the determined price for the component “B”. It should be appreciated that the purchase price of the HCA is not necessarily equivalent to that which would be the purchase price of product “B” bought separately. There may be additional costs, such as, but not limited to being, a surcharge to the client for the convenience of having three products integrated into one product.

If the product license converter does not find a match between the client's product license information and the table of product license information, then the HCA takes steps to acquire the one or more product licenses that are needed for the client to operate the HCA. It should be appreciated that the table of product license information may reside at the HCA or at a location accessible by the HCA but remote from the HCA.

In another embodiment, the client is able to input into the computer a list of previously owned licenses. The product license converter will then compare this manually entered list with a table of product license information, and determine which client product licenses are unused and convertible and which cover particular components of the HCA.

Thus, embodiments of the present technology enable product licenses for one product to be converted into product licenses for another product.

### Example Product License Converter

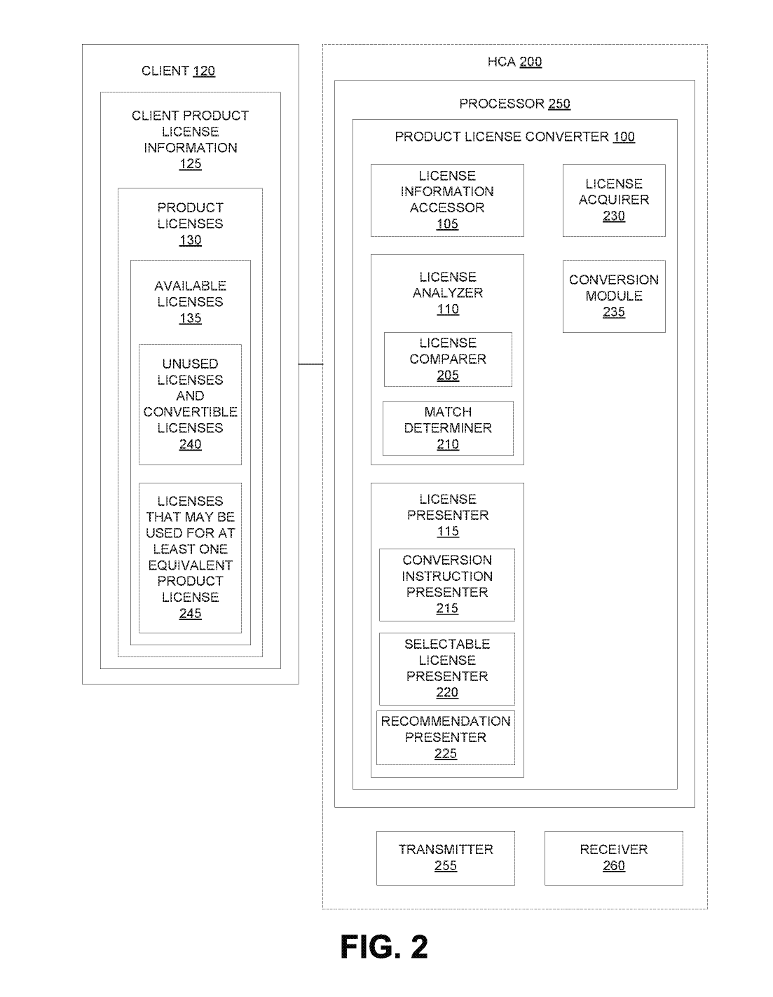

FIGS. 1 and 2 depict block diagrams illustrating a product license converter 100 that may reside at, or be external to though communicatively coupled with, an HCA 200. The product license converter 100 includes the following components coupled with a processor: a license information accessor 105; a license analyzer 110; and a license presenter 115. In various embodiments, the product license converter 100 optionally includes any of the following: a license acquirer 230; and a conversion module 235. The license analyzer 110, in various embodiments, optionally includes: a license comparer 205; and a match determiner 210. The license presenter 115, in various embodiments, optionally includes: a conversion instruction presenter 215; a selectable license presenter 220; and a recommendation presenter 225.

The license information accessor 105 accesses client product license information 125 for a client 120, wherein the client product license information 125 includes product licenses 130 acquired by said client 120. The license analyzer 110 determines if the client product license information 125 includes an available license 135 that covers the first product and that could cover the second product associated with the client 120. Of note, the client 120 is a customer who has purchased a second product (e.g., HCA 200). The client 120 may have already purchased a first product (a product purchased before the second product was purchased) and the license for the first product. The second product refers to a product bought after the first product was bought. In one embodiment, the second product, as described herein, is an HCA 200.

The license analyzer 110 determines if the client product license information 125 includes an available license 135 that covers the first product and that could cover the second product associated with the client 120. A second product being associated with the client 120 refers to the client 120 owning, leasing, and/or having authorization over the second product. For example, the client 120 may purchase an HCA, the second product, and thus owns the HCA. An available license 135 refers to a license being any of the following: unused; convertible; and for an equivalent product. For example, suppose a client 120 has a license for product “D” (which the client 120 owns) and then buys an HCA “Z” that integrates components (products) “D”, “E”, and “F”. The license analyzer 110 determines that the license for individually bought product “D” will be “unused” if the client 120 is using the HCA “Z”, and also determines that the license for the individually bought product “D” is able to be converted to being used as a product license for the HCA “Z” (and is thus, “convertible”). In another example, suppose a client 120 has a license for a product “G” (which the client 120 leases) and then buys an HCA “Y” that integrates components (products) “H” and “I”. The license analyzer 110 determines that the license for the individually product “G” is equivalent to the license for the product “I” of the HCA “Y”. Thus, the client 120 only is required to buy a license for the component “H” of the HCA “Y”, or some other determined price that accounts for component “H” in the context of the HCA “Y”.

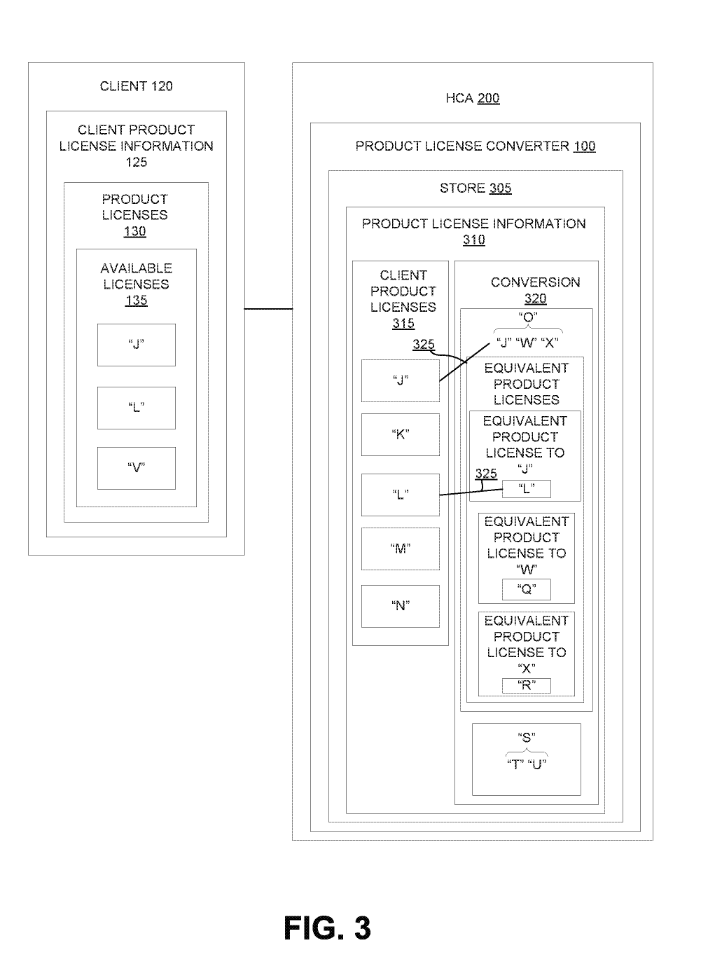

FIG. 3 is a block diagram illustrating the interaction, performed by the product license converter 100, between the client 120 and the table of product license information 300. As noted herein, the license analyzer 110 optionally includes: the license comparer 205; and the match determiner 210. In one embodiment, the license comparer 205 compares the client product license information to a store of product license information associated with the second product, such as the HCA 200. In one embodiment, the match determiner 210 matches a portion of the client product license information to a portion of the product licensing information, wherein a matched portion includes the available license(s) to cover the second product (e.g., HCA 200) associated with the client.

For example, and with reference to FIG. 3, an HCA 200 is shown with a product license converter 100 residing thereon. A store 305 is shown residing at the product license converter 100. A table 300 of product license information 310 is shown residing at the store 305. In another embodiment, the product license converter 100 resides external to, but communicatively coupled with, the HCA 200. In yet another embodiment, the store 305 resides external to, but communicatively coupled with, the product license converter 100. The table 300 of the product license information 310 has two columns, a column on the left labeled “client product licenses 315” and a column on the right labeled “conversion 320”. The client product licenses 315 column shows entries for product licenses, “J”, “K”, “L”, “M” and “N”. The conversion 320 column shows entries for the second product “O”, which is the HCA 200. The entry for the HCA “O” (comprising components “J”, “W” and “X”). Additionally, there may be entries in the table 300 for other HCA's, such as the HCA “S” (comprising components “T” and “U”). Under the HCA “O” is shown another entry illustrating that equivalent product licenses to “J” include the product license “L”, equivalent product licenses to “W” include the product license “Q” and equivalent product licenses to “X” include the product license “R”.

Thus, and with reference to the client product license information 125 and the table 300, the license comparer 205 of the license analyzer 110 compares the client product license information 125 to the store 305 of product license information 310 shown in the table 300 and that is associated with the second product (the HCA 200). As noted, in this example, the HCA 200 is the second product “O”.

The match determiner 210, based on the comparing, determines a match of a portion of the client product license information 125 to a portion of the product license information 310, wherein a matched portion includes the available license(s) 135 to cover the second product (HCA 200, product “O”) associated with the client 120. As can be seen by the connecting line 325, the table 300 shows that the client product license “J” matches with the product license “O” for HCA 200, as the product license “O” requires licenses for the components “J”, “W” and “X”. Additionally, as can be seen by the connecting line 330, the client product license “L” is equivalent to the product license “J”. Thus, using the table 300, the match determiner 210 determines the matched portion of the client's available licenses that cover the second product, the HCA 200. In this instance, the match determiner 210 determines that the client product license “J” matches the product license “O” of the HCA 200. Additionally, the match determiner 210 determines that that client product license “L” is equivalent to the product license “O” of the HCA 200.

The license presenter 115, if a status determination is made that the available license exists, then presents a discovered available license for conversion from covering the first product to cover the second product. For example, and with reference to the case scenario above, since a status determination was made by the match determiner 210 that a match exists and therefore, an available license 135 exists, then the license presenter 115 presents a discovered available license, such as the product license “J” and/or “L” for conversion, from covering the first product (for which the product license “J” covers) to covering the second product, HCA 200 (for which the product license “O” covers).

As noted above, the license presenter 115 optionally includes: the conversion instruction presenter 215; the selectable license presenter 220; and the recommendation presenter 225.

The conversion instruction presenter 215 presents instructions for the client to take steps to cause the discovered available license to be converted to cover the second product. For example and with reference to the case scenario above, the conversion instruction presenter 215 presents (e.g., via a display screen and/or audio) the instructions to the client 120, such that the client 120 may take the necessary steps to cause the available license that was determined to match (or be equivalent) at least a portion of the product license for the HCA 200 to be converted. These instructions may, in a non-limiting example, direct the client 120 to log onto a particular website address and follow instructions thereon for converting product licenses.

The selectable license presenter 220 presents at least one selectable license for selection for covering components of the second product. For example and with reference to the case scenario above, for the client 120 to be able to operate the HCA 200, the client must have acquired the necessary product licenses, those of product licenses, “J”, “W” and “X”. The selectable license presenter 220 presents (e.g., via a display screen and/or audio) at least one selectable license, such as product license “W” and “X” for selection for covering components of the HCA 200.

The recommendation presenter 225 presents a recommendation of a set of available licenses for the client to use. For example, the table 300 of product license information 310 may show that multiple product license, for which the client 120 has already acquired, may be converted to use for the product license of the second product. However, the recommendation presenter 225 determines which product licenses of the available and matched product licenses would be the best choice to use. This determination may take into any of the following factors, but is not limited to such: the unused product license age; the cost of the product for which the unused product license covers; the number of newer versions of the product for which the unused product license covers; how likely the client 120 is to use the product for which the unused product license covers; and any contractual restraints on the unused product license.

As noted herein, the product license converter 100 optionally includes any of the following: a license acquirer 230; and a conversion module 235.

The license acquirer 230, if the determination is made that the available license does not exist, then acquires one or more needed product licenses to cover the second product. For example and with reference to the case scenario above, if it was determined, by the license analyzer 110, that a client product license 130 does not exist, such as the product license “W” and “X”, then the license acquirer 230 acquires the needed product licenses, “W” and “X” to cover the second product. This acquisition, in one embodiment, is performed without consulting the client 120. In another embodiment, this acquisition is only performed after consulting with and receiving approval from the client 120.

The conversion module 235 converts the discovered available license to cover the second product. For example and with reference to the case scenario above, the conversion module 235 converts the discovered available license “J” and/or “L”, to cover the component “J” of the second product “O”. In one embodiment, this conversion is performed without consulting the client 120. In another embodiment, this conversion is only performed after consulting with and receiving approval for such conversion from the client 120.

In one embodiment, and with reference to FIGS. 1-3, a system for converting licenses from a first product to a second product includes: a hyper-converged appliance 200. The hyper-converged appliance 200 includes: a processor 250 comprising the product license converter 100; a transmitter 255; and a receiver 260. The transmitter 255 and the receiver 260 are under the control of the processor 250. The transmitter 255 sends a signal for accessing the client product license information 125 and for presenting the discovered available license for conversion. The receiver 260 receives the client product licensing information 125.

### Example Methods of Operation

The following discussion sets forth in detail some example methods of operation of embodiments. With reference to FIGS. 1-4, a flow diagram of method 400 for converting licenses from a first product to a second product is shown, in accordance with an embodiment. Method 400 includes some procedures that, in various embodiments, are carried out by a processor, such as processor 500 of FIG. 5, under the control of computer-readable and computer-executable instructions. In various embodiments, these computer-readable and computer-executable instructions are described as “code segments”, and presented separately (e.g., first codes segment, second code segment, etc.) to describe such instructions. In this fashion, procedures described herein and in conjunction with these flow diagrams, alone or in combination, are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, and optical disks, solid-state disks, any or all of which may be employed within a virtualization infrastructure. The computer-readable and computer-executable instructions, which reside on tangible computer readable storage media, are used to control or operate in conjunction with, for example, one or some combination of processors of a virtual machine. It is appreciated that the processor(s) may be physical or virtual or some combination (it should also be appreciated that a virtual processor is implemented on physical hardware).

The following discussion of method 400 references FIGS. 1-4 unless specifically noted otherwise.

At step 405 of method 400, in one embodiment and as described herein, client product licensing information is accessed, wherein the client product licensing information includes product licenses acquired by the client. For example, the client product licensing information 125 is accessed, wherein the client product licensing information 125 includes product licenses 130 acquired by the client 120.

At step 410 of method 400, in one embodiment and as described herein, it is determined if the client product license information includes an available license that covers the first product and that could cover the second product associated with the client. For example, it is determined if the client product license information 125 includes an available license 135 that covers the first product and that could cover the second product associated with the client 120.

In one embodiment and as described herein, the step 410 includes the step 415 of method 400: comparing the client product licensing information to a store of product license information associated with the second product; and matching a portion of the client product license information to a portion of the product license information, wherein the matched portion includes the available license to cover the second product associated with the client. For example, the client product license information 125 is compared to a store 305 of product license information 310 associated with the second product. Further, a portion of the client product license information 125 is matched to a portion of the product license information 310, wherein the matched portion includes the available license(s) 135 to cover the second product associated with the client 120.

At step 425 of method 400, in one embodiment and as described herein, if a status determination is made that the available license exists, then a discovered available license for conversion from covering the first product to cover the second product is presented. For example, if a status determination is made at step 410 that an available license(s) 135 exists, then the discovered available license (that is determined to exist) for conversion from covering the first product to cover the second product is presented.

In one embodiment and as described herein, the step 425 includes the step 430 of method 400: presenting instructions for the client 120 to take steps to cause the discovered available license to be converted to cover the second product. In one embodiment and as described herein, the step 425 includes the step 435 of method 400: presenting at least one selectable license for selection by the client 120 for covering the second product. In one embodiment and as described herein, the step 425 includes the step 440 of method 400: presenting a recommendation of a set of available licenses for said client to use.

At step 445, in one embodiment and as described herein, the method 400 further includes, if the determination is made that the available license 135 does not exist, then one or more needed product licenses are acquired to cover the second product.

At step 450, in one embodiment and as described herein, the method 400 further includes: purchases the one or more needed product licenses to cover the second product without consulting with the client 120.

At step 455, in one embodiment and as described herein, the method 400 further includes: converting the discovered available license to cover the second product.

### Example System for Converting Licenses

FIG. 6 is block diagram of a system 600 for converting licenses from a first product to a second product, in accordance with an embodiment. The system 600 includes a hyper-converged appliance 605 that includes: a processor 610; a transmitter 620; and a receiver 615.

The processor 610, in one embodiment: accesses client product license information for a client, wherein the client product license information comprises product licenses acquired by said client; determines if the client product license information comprises an available license that covers the first product and that could cover the second product associated with the client; and if a status determination is made that said available license exists, then presents a discovered available license for conversion from covering the first product to cover the second product.

The transmitter 620 sends a signal for accessing the client product license information and presents the discovered available license for conversion.

The receiver 615 receives the client product licensing information.

In one embodiment, the method 400 of FIG. 4 is performed by the system 600. For example, in one embodiment, the processor 610 performs step 405, accessing client product license information for the client, wherein the client product license information includes product licenses acquired by the client. In one embodiment, the processor 610 accesses the client product license information located at the receiver 615.

In yet another embodiment, the transmitter 620 sends a signal to access the client product license information that is located external to the system 600. As described, the receiver 615 then receives the client product license information, which is sent in response to the transmitter's 620 signal. However, of note, in various embodiments, the receiver 615 receives the client product license information at the initiation of an external source, and not the transmitter 620.

In one embodiment, the processor 610 performs step 410, determining if the client product license information includes an available license that covers the first product and that could cover the second product associated with the client. Then, in one embodiment, the processor 610 performs step 425, presenting a discovered available license for conversion from covering the first product to cover the second product, if a status determination (from step 410) is made that the available license exists. In one embodiment, the transmitter 620 aids in the presenting of available license for conversion of step 425.

Thus, the system 600, and the hyper-converged appliance 605 thereof, is able to perform the method 400 of FIG. 4, according to an embodiment.

Example Computer System

With reference now to FIG. 5, all or portions of some embodiments described herein are composed of computer-readable and computer-executable instructions that reside, for example, in computer-usable/computer-readable storage media of a computer system. That is, FIG. 5 illustrates one example of a type of computer (computer system 500) that can be used in accordance with or to implement various embodiments which are discussed herein. It is appreciated that computer system 500 of FIG. 5 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, distributed computer systems, media centers, handheld computer systems, multi-media devices, and the like. Computer system 500 of FIG. 5 is well adapted to having peripheral non-transitory computer-readable storage media 502 such as, for example, a floppy disk, a compact disc, digital versatile disc, other disc based storage, universal serial bus “thumb” drive, removable memory card, and the like coupled thereto.

System 500 of FIG. 5 includes an address/data bus 504 for communicating information, and a processor 506A coupled with bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. System 500 also includes data storage features such as a computer usable volatile memory 508, e.g., random access memory (RAM), coupled with bus 504 for storing information and instructions for processors 506A, 506B, and 506C.

System 500 also includes computer usable non-volatile memory 510, e.g., read only memory (ROM), coupled with bus 504 for storing static information and instructions for processors 506A, 506B, and 506C. Also present in system 500 is a data storage unit 512 (e.g., a magnetic or optical disk and disk drive) coupled with bus 504 for storing information and instructions. System 500 also includes an optional alphanumeric input device 514 including alphanumeric and function keys coupled with bus 504 for communicating information and command selections to processor 506A or processors 506A, 506B, and 506C. System 500 also includes an optional cursor control device 516 coupled with bus 504 for communicating user input information and command selections to processor 506A or processors 506A, 506B, and 506C. In one embodiment, system 500 also includes an optional display device 518 coupled with bus 504 for displaying information.

Referring still to FIG. 5, optional display device 518 of FIG. 5 may be a liquid crystal device, cathode ray tube, plasma display device or other display device suitable for creating graphic images and alphanumeric characters recognizable to a user. Optional cursor control device 516 allows the computer user to dynamically signal the movement of a visible symbol (cursor) on a display screen of display device 518 and indicate user selections of selectable items displayed on display device 518. Many implementations of cursor control device 516 are known in the art including a trackball, mouse, touch pad, joystick or special keys on alphanumeric input device 514 capable of signaling movement of a given direction or manner of displacement. Alternatively, it will be appreciated that a cursor can be directed and/or activated via input from alphanumeric input device 514 using special keys and key sequence commands. System 500 is also well suited to having a cursor directed by other means such as, for example, voice commands. System 500 also includes an I/O device 520 for coupling system 500 with external entities. For example, in one embodiment, I/O device 520 is a modem for enabling wired or wireless communications between system 500 and an external network such as, but not limited to, the Internet.

Referring still to FIG. 5, various other components are depicted for system 500. Specifically, when present, an operating system 522, applications 524, modules 526, and data 528 are shown as typically residing in one or some combination of computer usable volatile memory 508 (e.g., RAM), computer usable non-volatile memory 510 (e.g., ROM), and data storage unit 512. In some embodiments, all or portions of various embodiments described herein are stored, for example, as an application 524 and/or module 526 in memory locations within RAM 508, computer-readable storage media within data storage unit 512, peripheral computer-readable storage media 502, and/or other tangible computer-readable storage media.

What we claim is:

1. An article of manufacture, which comprises a computer readable medium having stored therein a computer program for a method of converting licenses from a first product to a second product, said computer program comprising:
a first code segment which, when executed on a computer, accesses client product license information for a client, wherein said client product license information comprises product licenses acquired by said client;
a second code segment which, when executed on said computer, determines if said client product license information comprises an available license that covers said first product and that could cover said second product associated with said client; and
a third code segment which, when executed on said computer, if a status determination is made that said available license exists, then presents a discovered available license for conversion from covering said first product to cover said second product.

2. The article of manufacture of claim 1, further comprising:
a fourth code segment which, when executed on said computer, if said determination is made that said available license does not exist, then acquires one or more needed product licenses to cover said second product.

3. The article of manufacture of claim 2, further comprising:
a fifth code segment which, when executed on said computer, purchases said one or more needed product licenses to cover said second product without consulting with said client.

4. The article of manufacture of claim 1, further comprising:
a sixth code segment which, when executed on said computer, converts said discovered available license to cover said second product.

5. The article of manufacture of claim 1, wherein said second code segment comprises:
a seventh code segment which, when executed on said computer, compares said client product license information to a store of product license information associated with said second product;
an eighth code segment which, when executed on said computer, matches a portion of said client product license information to a portion of said product license information, wherein said matched portion comprises said available license to cover said second product associated with said client.

6. The article of manufacture of claim 1, wherein said third code segment comprises:
a ninth code segment which, when executed on said computer, presents instructions for said client to take steps to cause said discovered available license to be converted to cover said second product.

7. The article of manufacture of claim 1, wherein said third code segment comprises:
a tenth code segment which, when executed on said computer, presents at least one selectable license for selection by said client for covering said second product.

8. The article of manufacture of claim 1, wherein said third code segment comprises:
an eleventh code segment which, when executed on said computer, presents a recommendation of a set of available licenses for said client to use.

9. A product license converter for converting licenses from a first product to a second product, said product license converter comprising:
a license information accessor coupled with a processor, said license information accessor for accessing client product license information for a client, wherein said client product license information comprises product licenses acquired by said client;
a license analyzer coupled with said processor, said license analyzer for determining if said client product license information comprises an available license that covers said first product and that could cover said second product associated with said client; and
a license presenter coupled with said processor, said license presenter for, if a status determination is made that said available license exists, then presenting a discovered available license for conversion from covering said first product to cover said second product.

10. The product license converter claim 9, further comprising:
a license acquirer coupled with said processor, said license acquirer for, if said determination is made that said available license does not exist, then acquiring one or more needed product licenses to cover said second product.

11. The product license converter of claim 9, further comprising:
a conversion module coupled with said processor, said conversion module for converting said discovered available license to cover said second product.

12. The product license converter of claim 9, wherein said license analyzer comprises:
a license comparer for comparing said client product license information to a store of product license information associated with said second product; and
a match determiner for matching a portion of said client product license information to a portion of said product license information, wherein a matched portion comprises said available license to cover said second product associated with said client.

13. The product license converter of claim 9, wherein said license presenter comprises:
a conversion instruction presenter for presenting instructions for said client to take steps to cause said discovered available license to be converted to cover said second product.

14. The product license converter of claim 9, wherein said license presenter comprises:
a selectable license presenter for presenting at least one selectable license for selection for covering components of said second product.

15. The product license converter of claim 9, wherein said license presenter comprises:
a recommendation presenter for presenting a recommendation of a set of available licenses for said client to use.

16. The product license converter of claim 9, wherein said available licenses comprise unused and convertible licenses.

17. The product license converter of claim 16, wherein said available licenses comprise licenses that may be used for at least one equivalent product.

18. The product license converter of claim 9, wherein said product license converter operates remote from said second product.

19. The product license converter of claim 9, wherein said product license converter operates local to said second product.

20. A system for converting licenses from a first product to a second product, said system comprising:
a hyper-converged appliance comprising:
a processor configured for:
accessing client product license information for a client, wherein said client product license information comprises product licenses acquired by said client;
determining if said client product license information comprises an available license that covers said first product and that could cover said second product associated with said client; and
if a status determination is made that said available license exists, then presenting a discovered available license for conversion from covering said first product to cover said second product;
a transmitter for sending a signal for accessing said client product license information and presenting said discovered available license for conversion; and
a receiver for receiving said client product licensing information.
